(19) United States
(12) Patent Application Publication
(10) Pub. No.: US 2011/0314223 A1
(43) Pub. Date: Dec. 22, 2011

(54) SYSTEM FOR PROTECTING AGAINST CACHE RESTRICTION VIOLATIONS IN A MEMORY

(76) Inventors: Yair Orbach, Shomron (IL); Nahum N. Vishne, Elad (IL); Assaf Rachlevski, Modiin (IL); Alex Shinkar, Rishon-Lezion (IL)

(21) Appl. No.: 12/817,345

(22) Filed: Jun. 17, 2010

(51) Int. Cl. G06F 12/02; G06F 12/08

(52) U.S. Cl. 711/118; 711/202; 711/E12.002; 711/E12.016

(57) ABSTRACT

An apparatus comprising a plurality of tag circuits, a plurality of compare circuits and a processing circuit. The plurality of tag circuits may each be configured to store memory mapping data. The plurality of compare circuits may each be configured to generate a respective compare result in response to a match between the memory mapping data of a respective one of the tag circuits and a respective one of a plurality of tag fields. The processing circuit may be configured to receive each of the compare results from the plurality of compare circuits. The processing circuit may also be configured to count occurrences of the matches. If more than one match is identified within a predetermined time, the processing circuit may invalidate the memory mapping data and the tag field. If more than one match is identified within a predetermined time, the processing circuit may also re-fetch the memory mapping data.

### FIELD OF THE INVENTION

The present invention relates to memories generally and, more particularly, to a method and/or apparatus for implementing protection against cache restriction violations in a memory.

### BACKGROUND OF THE INVENTION

Many conventional cache systems allow backdoor accesses that enable a user to optimize cache usage, monitor cache efficiency and control cache efficiency. Backdoor access operations (such as writing tag values, altering segments and other sensitive controls) can create inconsistencies in the cache. These inconsistencies are at times unintentionally overlooked during regular operation. Inconsistencies can create a state where the main memory is not reflected correctly by the cache.

A user is restricted when using backdoor access operations by adhering to certain constraints, such as disabling the cache or making certain that no accesses are being processed by the cache while altering sensitive control registers. Many cache systems provide a user with status bits that reflect the internal state needed for guaranteeing safe changes to the control bit state. In certain environments, such as a multi-tasking environment, even a careful user may violate the constraints and create an inconsistency that will lead to corrupted data. The corrupted data is often very difficult to locate. Corrupted data causes failures that seem to be random and difficult to characterize and debug. Often, the cause of failure is difficult to identify as being related to hardware, software development tools, or application software.

It would be desirable to implement a cache system that provides protection against restriction violations.

### SUMMARY OF THE INVENTION

The present invention concerns an apparatus comprising a plurality of tag circuits, a plurality of compare circuits and a processing circuit. The plurality of tag circuits may each be configured to store memory mapping data. The plurality of compare circuits may each be configured to generate a respective compare result in response to a match between the memory mapping data of a respective one of the tag circuits and a respective one of a plurality of tag fields. The processing circuit may be configured to receive each of the compare results from the plurality of compare circuits. The processing circuit may also be configured to count occurrences of the matches. If more than one match is identified within a predetermined time, the processing circuit may invalidate the memory mapping data and the tag field. If more than one match is identified within a predetermined time, the processing circuit may also re-fetch the memory mapping data.

The objects, features and advantages of the present invention include providing cache restriction violation protection that may (i) identify a restriction violation, (ii) characterize the cause of the violation, (iii) identify the timing of the violation event, (iv) protect data integrity and/or (v) enable easy recovery from the inconsistency.

### BRIEF DESCRIPTION OF THE DRAWINGS

These and other objects, features and advantages of the present invention will be apparent from the following detailed description and the appended claims and drawings in which:

FIG. 1 is a block diagram of a cache system implementing a duplicated tag detector;

FIG. 2 is a flow chart for implementing duplicated tag detector logic;

FIG. 3 is a block diagram of a cache system implementing a missing segment detector;

FIG. 4 is a flow chart for implementing missing segment detector logic;

FIG. 5 is a block diagram for implementing a duplicated tag detector with logic gate circuits;

FIG. 6 is a block diagram for implementing a missing segment detector with logic gate circuits; and

FIG. 7 is a block diagram of a multi-core memory cache system.

### DETAILED DESCRIPTION OF THE PREFERRED EMBODIMENTS

The present invention provides protection logic that identifies inconsistencies caused by restriction violations, protects data integrity by invalidating corrupted lines, and/or contains a status bit and/or an interrupt to provide information for users to debug the exact restriction being violated.

In cache logic, tags may contain the mapping of virtual memory to actual memory. For some cache implementations, there may be an additional level of mapping of virtual memory segments to actual memory segments. Cache segment logic implementation may provide tags which are more efficient than direct mapping. As a result, the tags may be smaller. However, tags reside in a limited set of segments. When an address from a segment that does not reside in the cache is needed, cache logic performs segment replacements.

The present invention adds additional cache logic that may check tag duplication and/or missing segments. When a tag is detected in the cache, a hit has occurred. When a tag is not detected in the cache, a miss has occurred. When multiple hits are detected, the logic may invalidate both tags that have a hit. In such a case, a miss has occurred and the controller re-fetches the data. When an address of the data filled into the cache does not have any matching segment, the cache may transfer the data but not store the data in the cache. In such a case, a second access to the same address will be identified as a miss.

For some processors, such events, in additions to setting error bits, create precise exceptions which may enable the user to track the precise timing of the event causing the exception. This functionality may be documented to enable the software developer to use the error bits and precise exceptions for debugging purposes. In a case where the tag duplication and missing segments logic is used for protection only, noticing that such logic is active is difficult since the impact on performance is very small. A user may create inconsistencies deliberately to verify that the system does not corrupt the data and/or to assure that the tag duplication and missing segments logic is being used and/or is working properly. The present invention may implement cache logic to identify the special scenario for detecting an event causing a restriction violation.

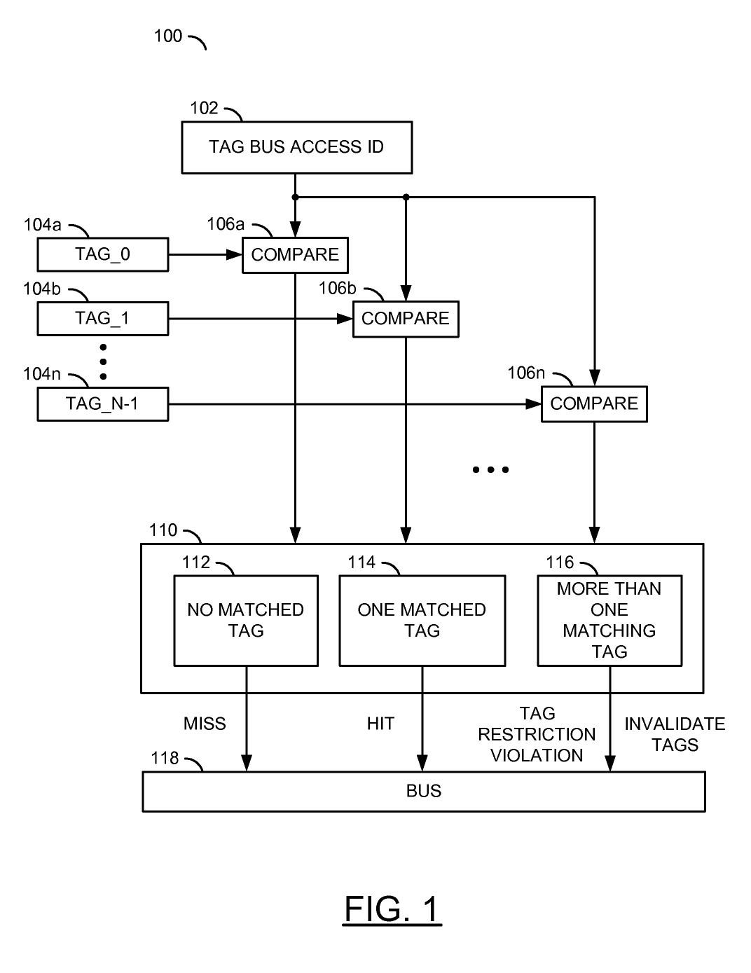

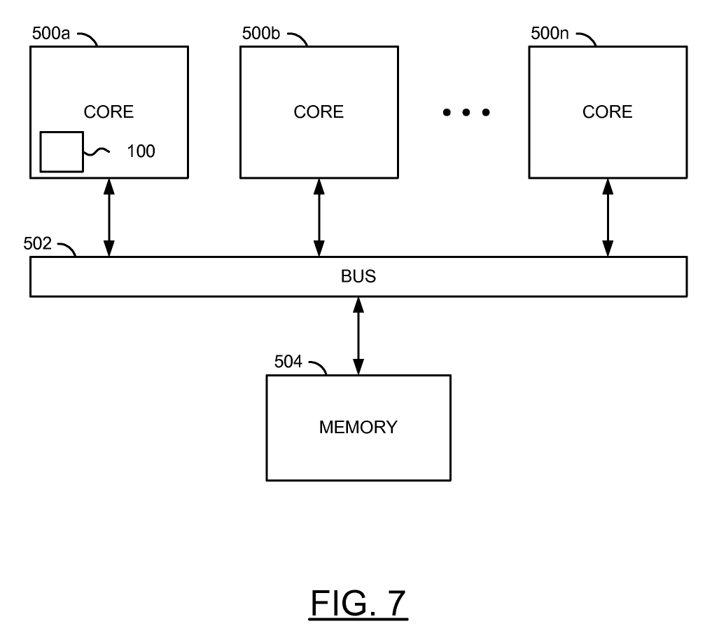

Referring to FIG. 1, a block diagram of a circuit 100 is shown in accordance with a preferred embodiment of the present invention. The circuit 100 generally comprises a block (or circuit) 102, a number of blocks (or circuits) 104a-104n, a number of blocks (or circuits) 106a-106n, a block (or circuit) 110 and a block (or circuit) 118. The circuit 110 may comprise a block (or circuit) 112, a block (or circuit) 114 and a block (or circuit) 116. The circuit 102 may be implemented as a tag bus access ID circuit. The circuits 104a-104n may be implemented as tag circuits. The circuits 106a-106n may be implemented as compare circuits. The circuit 110 may be implemented as a processing circuit. The circuit 118 may be implemented as a bus. The circuit 100 may be implemented as a cache controller with a duplicate tag detector. A cache memory (shown in more detail in connection with FIG. 7) may be connected to the bus 118. The circuit 112 may be implemented to identify no matched tags. The circuit 114 may be implemented to identify one matched tag. The circuit 116 may be implemented to identify more than one matching tag.

For a duplicated tag detector, each tag may first be compared with the tag field of the address. The circuit 102 may contain the tag field needed for bus access. The tag circuits 104a-104n may be compared with the tag field stored in the circuit 102. This comparison may be part of a regular cache operation for identifying hits and/or misses. If no matching tags are identified in the cache, a miss has occurred. If one matching tag is identified in the cache, a hit has occurred. If more than one matching tags are identified in the cache, a tag restriction violation may be set and the tags may be invalidated.

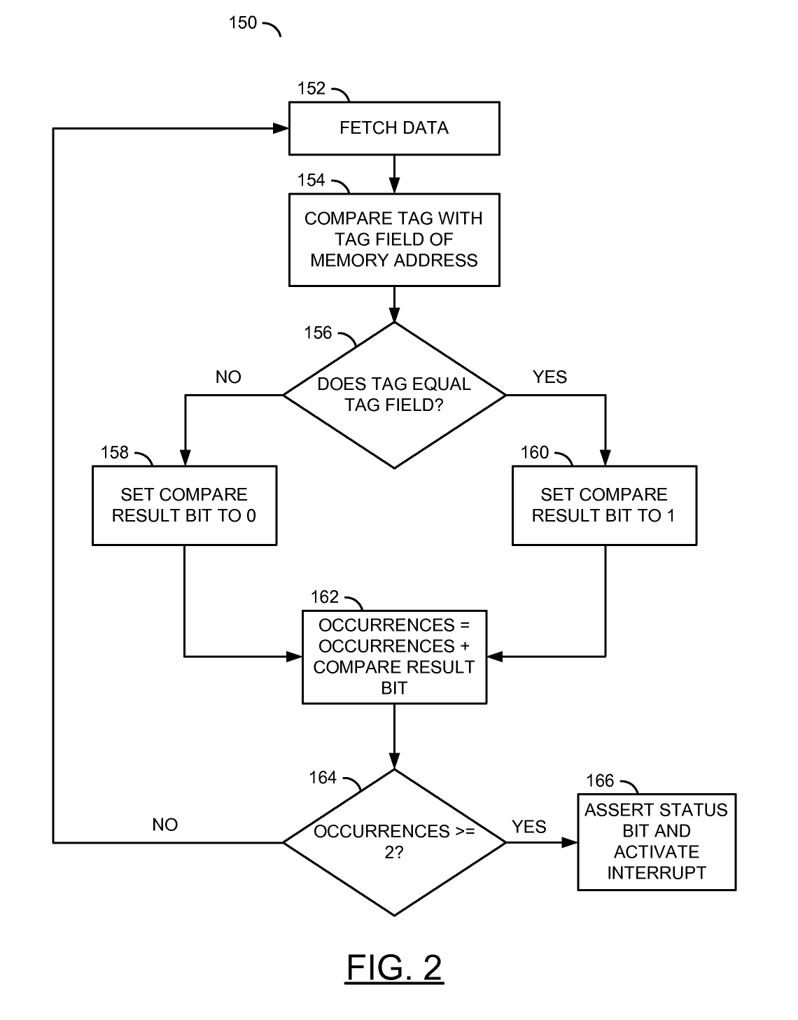

Referring to FIG. 2, a flow chart of a method (or process) 150 for implementing duplicated tag detector logic is shown. The process 150 generally comprises a step (or state) 152, a step (or state) 154, a decision step (or state) 156, a step (or state) 158, a step (or state) 160, a step (or state) 162, a decision step (or state) 164 and a step (or state) 166. The compare result bit may be set to a logical “1” for equal. The compare result bit may be set to a logical “0” for not equal. However, the particular polarity of the compare result bit may be varied to meet the design criteria of a particular implementation. The duplicated tag detector logic 110 may then count occurrences of the number of logical “1”. For example, the occurrences of the number of logical “1” (e.g., tag matches) is equal to or larger than 2, a status bit signal may be asserted and an interrupt may be activated. The interrupt may enable debug tools to identify the instruction that caused the interrupt and the values of the registers before the instruction is executed (e.g., break before make). However, the particular coding of the duplicated tag detector logic may be varied to meet the design criteria of a particular implementation.

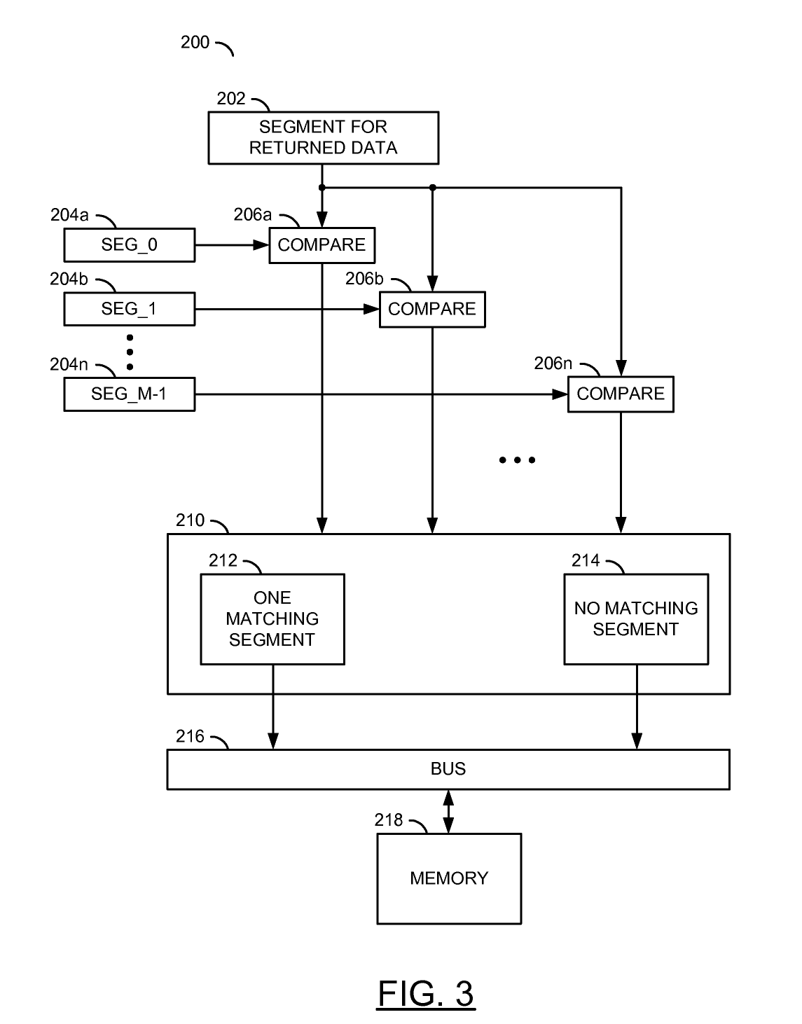

Referring to FIG. 3, a block diagram of a circuit 200 is shown in accordance with a preferred embodiment of the present invention. The circuit 200 generally comprises a block (or circuit) 202, a number of blocks (or circuits) 204a-204n, a number of blocks (or circuits) 206a-206n, a block (or circuit) 210, a block (or circuit) 216 and a block (or circuit) 218. The circuit 210 may comprise a block (or circuit) 212 and a block (or circuit) 214. The circuit 202 may be implemented as a segment circuit. The circuit 204a-204n may be implemented as segment circuits. The circuits 206a-206n may be implemented as compare circuits. The circuit 210 may be implemented as a processing circuit. The circuit 216 may be implemented as a bus circuit. The circuit 218 may be implemented as a memory circuit. The circuit 200 may be implemented as a cache system with a missing segment detector. The circuit 212 may be implemented to identify if one matching segment occurs. The circuit 214 may be implemented to identify no matching segments occur.

For a missing segment detector, each segment may first be compared with the segment field of the address. In one example, such a comparison may be part of a regular cache operation for identifying segment hits and/or misses. If one matching segment is identified, data may be transferred to the bus 216. The data may then be stored in the cache memory connected to the bus 216 and the tag may be updated. A valid pointing to the proper segment may then occur. If no matching segments are identified, data may be transferred to the bus 216. However, in such a scenario (e.g., if no matching segments are identified) data is not normally stored in the cache, tags are not normally updated and/or valid pointing does not normally occur. In general, the logic shown in FIG. 2 may detect a double TAG at the beginning of the address processing to decide whether the cache controller needs to take the data from the cache memory (a hit) or take the data from the external memory (a miss). The logic shown in FIG. 3 may be activated when the miss data returns from the external memory. The restriction may be checked to verify that the segment of the miss line was not replaced.

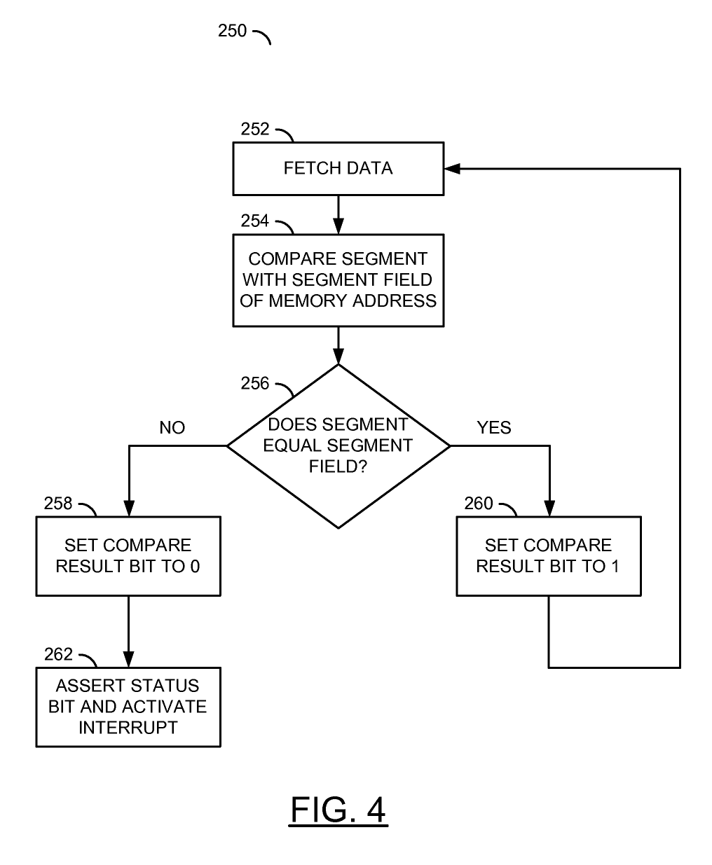

Referring to FIG. 4, a flow chart of a method (or process) 250 is shown. The method 250 may be used for implementing missing segment detector logic 210. The process 250 generally comprises a step (or state) 252, a step (or state) 254, a decision step (or state) 256, a step (or state) 258, a step (or state) 260 and a step (or state) 262. First, data may be initially fetched. Then the segment may be compared with the segment field of the memory address. If the segment equals the segment field, then the compare result bit may be set to a logical “1” for equal. If the segment does not equal the segment field, then the compare result bit may be set to a logical “0”. If the compare result bit is set to a logical “0”, then a status bit signal may be asserted and a precise interrupt may be activated. However, the particular coding of the missing segment detector logic may be varied to meet the design criteria of a particular implementation.

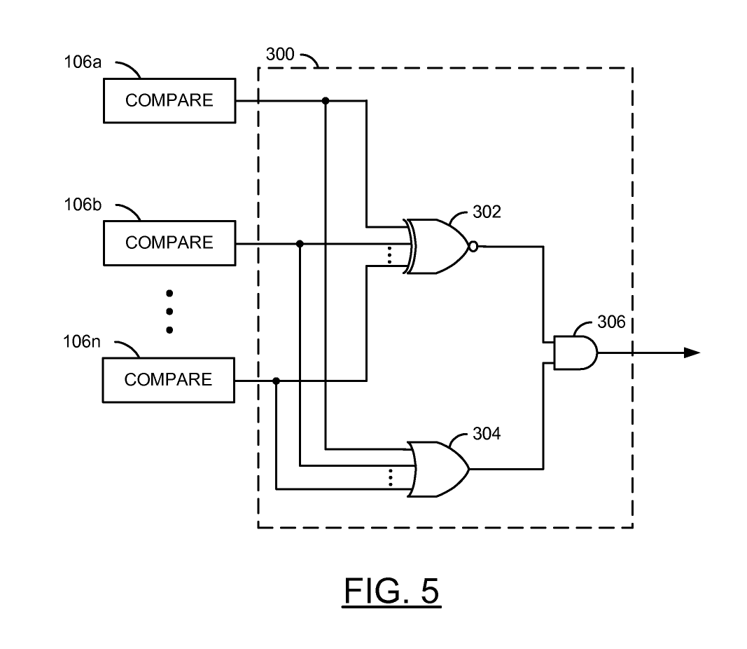

Referring to FIG. 5, a block (or circuit) 300 for implementing a duplicated tag detector with logic gates is shown. The circuit 300 may comprise a block (or circuit) 302, a block (or circuit) 304 and a block (or circuit 306). The circuit 302 may be implemented as an XOR-NOT logic gate circuit. The circuit 304 may be implemented as an OR logic gate circuit. The circuit 306 may be implemented as an AND logic gate circuit. However, other variations of the circuit 300 (e.g., varying the logic of the circuit 302 and/or the circuit 304) may be used to implement logic for a tag detector. The duplicated tag detector logic 210 may be minimized in an implementation when more than 2 matching tags are unlikely to occur. Under such an assumption, the XOR-NOT logic gate 302 of all comparator outputs may detect an even number, or a logical “1”. The OR logic gate 304 of all comparator outputs may detect if the total occurrences of the number of logical “1” is more than zero. If both the XOR-NOT logic gate 302 and the OR logic gate 304 are set to a logical “1”, then 2 matching tags has occurred.

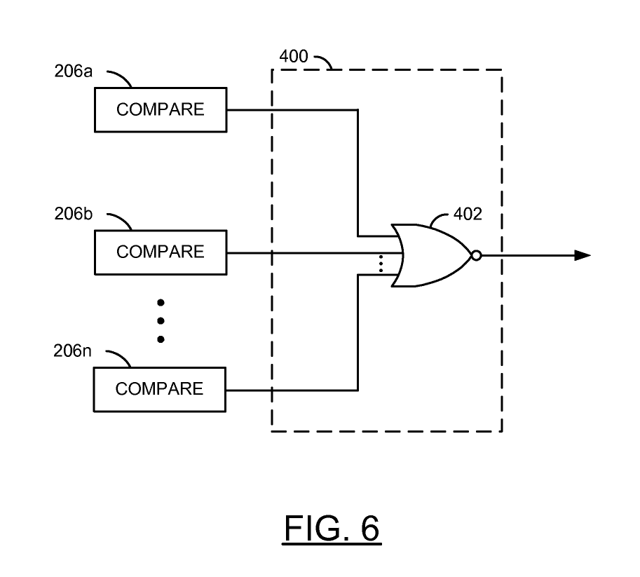

Referring to FIG. 6, a block (or circuit) 400 for implementing a missing segment detector with logic gate circuits is shown. The circuit 400 may comprise a block or circuit) 402. The circuit 402 may be implemented as NOR logic gate circuit. However, other variations of the circuit 400 may be used to implement logic for a missing segment detector. The detection of the no matching segment event may be performed by the NOR logic gate 402 of all comparator outputs. If there is not a matching segment, then the NOR logic gate 402 output may be a logical “1”. If the NOR logic gate 402 output is a logical “1”, the status bit may be asserted and an interrupt may be activated. The interrupt may enable debug tools to identify the instruction that caused the interrupt and the values of the registers before the instruction is executed (“break before make”).

Referring to FIG. 7, a diagram of a multi-core memory cache system is shown. The system may comprise a plurality of blocks (or circuits) 500a-500n, a block (or circuit) 502 and a block (or circuit 504). Each of the plurality of circuits 500a-500n may be implemented as a core circuit. The circuit 502 may be implemented as a bus. The circuit 504 may be implemented as a memory circuit. Each of the plurality of circuits 500a-500n may include an implementation of the circuit 100. The memory 504 may be implemented as a cache memory. The memory 504 may be accessed by each of the processors 500a-500n.

The various signals of the present invention are generally “on” (e.g., a digital HIGH, or 1) or “off” (e.g., a digital LOW, or 0). However, the particular polarities of the on (e.g., asserted) and off (e.g., de-asserted) states of the signals may be adjusted (e.g., reversed) to meet the design criteria of a particular implementation. Additionally, inverters may be added to change a particular polarity of the signals.

The functions performed by the diagrams of FIGS. 2 and 4 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products) or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a plurality of tag circuits each configured to store memory mapping data;
a plurality of compare circuits each configured to generate a respective compare result in response to a match between said memory mapping data of a respective one of said tag circuits and a respective one of a plurality of tag fields; and
a processing circuit configured to (i) receive each of said compare results from said plurality of compare circuits and (ii) count occurrences of said matches, wherein if more than one match is identified within a predetermined time, said processing circuit (a) invalidates said memory mapping data and said tag field and (b) re-fetches said memory mapping data.

2. The apparatus according to claim 1, wherein said memory mapping data is re-fetched from a main memory.

3. The apparatus according to claim 1, wherein said predetermined time defines a time needed to allow each of said tag circuits to be refreshed.

4. The apparatus according to claim 1, wherein said apparatus comprises a cache controller.

5. The apparatus according to claim 1, wherein said tag circuits read said memory mapping data from a cache memory.

6. The apparatus according to claim 1, wherein said apparatus prevents a violation of a cache memory.

7. The apparatus according to claim 1, wherein said processing circuit is configured to generate an interrupt that provides information to debug said apparatus if more than one match is identified.

8. The apparatus according to claim 1, wherein said apparatus identifies inconsistencies caused by restriction violations.

9. The apparatus according to claim 1, wherein said apparatus protects data integrity when said processing circuit invalidates said memory mapping data.

10. An apparatus comprising:
means for storing memory mapping data in a plurality of tag circuits;
means for generating a respective compare result in response to a match between said memory mapping data of a respective one of said tag circuits and a respective one of a plurality of tag fields; and
means for processing to (i) receive each of said compare results from said plurality of compare circuits and (ii) count occurrences of said matches, wherein if more than one match is identified within a predetermined time, said processing circuit (a) invalidates said memory mapping data and said tag field and (b) re-fetches said memory mapping data.

11. A method for protecting against cache restriction violations, comprising the steps of:
(A) storing memory mapping data in a plurality of tag circuits;
(B) generating a respective compare result in response to a match between said memory mapping data of a respective one of said tag circuits and a respective one of a plurality of tag fields; and
(C) receiving each of said compare results from said plurality of compare circuits;
(D) counting occurrences of said matches; and
(E) if more than one match is identified within a predetermined time, invalidating said memory mapping data and said tag field and re-fetching said memory mapping data.

12. The method apparatus according to claim 11, wherein said memory mapping data is re-fetched from a main memory.

13. The method according to claim 11, wherein said predetermined time defines a time needed to allow each of said tag circuits to be refreshed.

14. The method according to claim 11, wherein said method is implemented in a cache controller.

15. The method according to claim 11, wherein said tag circuits read said memory mapping data from a cache memory.

16. The method according to claim 11, wherein said method prevents a violation of a cache memory.

17. The method according to claim 11, wherein step (C) generates an interrupt that provides information to debug said method if more than one match is identified.

18. The method according to claim 11, wherein said method identifies inconsistencies caused by restriction violations.

19. The method according to claim 11, wherein said method protects data integrity when said memory mapping data is invalidated.
